(19) United States
(12) Patent Application Publication
(10) Pub. No.: US 2006/0107568 A1
(43) Pub. Date: May 25, 2006

(54) Display device, particularly for traffic signs

(76) Inventors: Anrea Nicholini, Tortona (IT); Egidio Bracco, Tortona (IT)

Correspondence Address: YOUNG & THOMPSON, 745 SOUTH 23RD STREET, 2ND FLOOR, ARLINGTON, VA, 22202, US

(21) Appl. No.: 10/531,987

(22) PCT Filed: Feb. 25, 2003
(86) PCT No.: PCT/IB03/00704

§ 371 Date: Nov. 1, 2005

(30) Foreign Application Priority Data
Oct. 21, 2002 (IT) MI2002A002227

(51) Int. Cl. G09F 13/18

(52) U.S. Cl. 40/546

(57) ABSTRACT

Disclosed is a display device of the type having: a sheet made of light-diffusing material; lighting elements positioned on either side of the diffusing layer; a medium made of transparent material with the image to be displayed applied to it; characterised in that the diffuser is constituted by a sheet of plastic with at least one surface which presents micro-grooves a few microns deep, so as to form a matt surface, and that the lighting elements are constituted by LEDs.

This invention relates to a display device of the type comprising a support for a sheet bearing an image to be displayed, lighting devices located on the perimeter in relation to the image, and means designed to diffuse the light produced by said devices to backlight said image, wherein said diffuser means are constituted by a layer of suitable plastic, in particular plexiglass, which presents at least one surface machined with micro-grooves a few microns deep to produce a matt surface.

The result of this characteristic is that light is diffused far more uniformly, especially with lighting devices constituted by LEDs.

According to one characteristic of the invention, the LEDs will be advantageously fitted on a track or support which can easily be removed from the structure for inspection and repair.

The device according to the invention can have numerous applications, for example to make luminous sign panels, road signs and indicator panels.

If a photograph printed on a transparent sheet is used as the image, said device could also have numerous other applications, for example in the advertising industry, in sales outlets, and so on.

Italian utility patent application no. MI2000U000480 relates to a backlit road and motorway sign with a fixed message comprising:

a layer of diffusing material;

lighting means positioned on either side of said diffusing layer;

a sheet of transparent material with a pictogram that represents the sign to be displayed, attached to said diffuser layer.

This solution, which constitutes the prior art most similar to the present invention, uses neon lamps, in particular CCFL lamps, as the main lighting source, and a diffuser layer made of transparent plexiglass with perfectly smooth surfaces.

The text refers to the possibility of replacing neon lamps with LEDs, but in practice this solution has proved less interesting than the one with CCFL lamps, because LEDs diffuse light unevenly, leading to uneven background lighting.

As the use of LEDs instead of neon lamps presents various advantages, such as a lower consumption and greater strength and durability of the lamps, solutions have been sought which would enable a sign with excellent light transmission and diffusion characteristics to be obtained when the light is generated by LEDs.

Numerous attempts and experiments have led the present applicant to develop a display device, which forms the subject of the present invention, characterised by the fact that for the purpose of diffusion, it uses a sheet of plexiglass with a matt surface, ie. a surface with micro-grooves a few microns deep which is smooth but not shiny.

The measurements performed show that this type of diffuser diffuses light in a perfectly uniform way, with the result that the observer of the signal cannot tell whether the lamps are positioned on one side or the other.

It was then unexpectedly discovered that with this solution, the transmission of light to the front of the panel considerably increases, the quantity of transmitted light being approximately one-and-a-half times that transmitted by the signs used in the known technique.

These and other characteristics will appear more clearly from the detailed description set out below, provided by way of example but not of limitation, by reference to the annexed figures wherein:

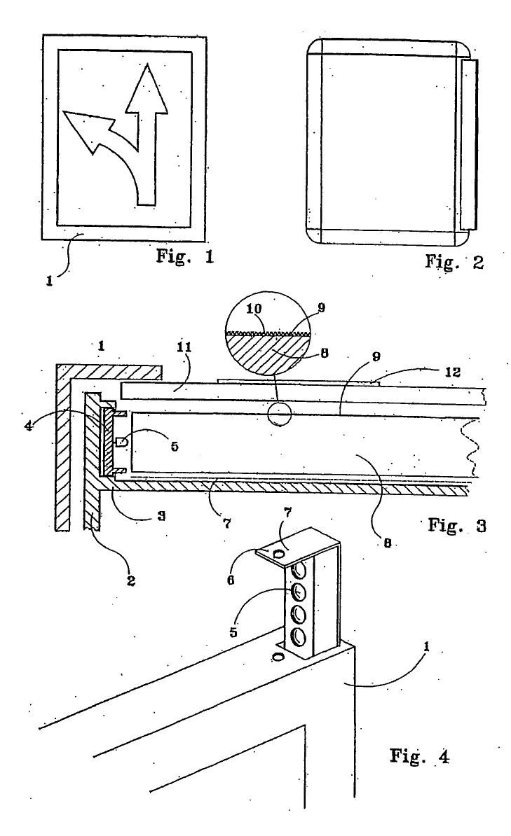

FIG. 1 is a view of a road sign made according to the invention;

FIG. 2 is a view of a display device according to the invention which has a different application;

FIG. 3 shows the road sign illustrated in FIG. 1 in cross-section;

FIG. 4 schematically illustrates a perspective view of the lighting devices used in the display device according to the invention, during assembly.

In FIGS. 1 and 2, the display device according to the invention comprises a frame 1 constituted, for example, by a metal structural section or the like, to which is fixed the surround 2 of a wall 3 which constitutes the back wall of the display device.

Surround 2 is shaped in the form of a track so that it can receive a structural section 4 that constitutes the support for a plurality of LEDs 5, which provide the lighting required by the display device.

The end of support 4 is fitted with a plate 6 containing a hole 7 for a screw used to fix it to frame 1.

Back wall 3 will preferably be covered with a reflecting layer 7, such as a coat of paint or an applied sheet of reflecting material.

A diffuser 8, consisting of a sheet of transparent plastic such as plexiglass, in particular a sheet of the material sold under the name Plexiglas GS 10011002 by the company Rhom Italy S.r.l., for example, which is designed to diffuse the light originating from side LEDs 5 and distribute it evenly over the entire surface of the panel, is fitted in frame 1. The characteristic feature of the invention is that at least one surface of said sheet, shown as 9 in FIG. 3, is machined with a set of micro-grooves a few microns deep, so as to produce a matt surface.

Tests show that this characteristic ensures perfect, uniform diffusion of light and also improves light transmission, with the result that the light flow which exits from the front surface of the panel is superior to that observed with panels made according to the known technique, in which the diffuser surfaces are perfectly shiny.

The panel is completed by a support constituted by a polycarbonate screen 11 that bears the image to be displayed, which is reproduced, for example, on a back-reflecting film applied to screen 11.

According to a particular embodiment of the same idea, frame 1 is constituted by structural sections with one edge hinged so that it can be opened, as shown in FIG. 2.

This means that the film bearing the image to be displayed can be replaced quickly and easily, as it is simply mounted by resting it on the polycarbonate screen.

This easy replacement of the image considerably broadens the field of application of the display device which, in addition to road signs, could be used, for example, in bars and restaurants to display messages, advertising and the like.

For example, it would be easy to make display devices for notices, menus and the like.

Moreover, the efficacy of the light diffusion by sheet 8 means that lighting sources could be installed on only one or two sides of the panel, leaving the other sides free, for the purpose of inserting and/or removing the image media to ensure easy replacement, for example, or fitting a moving tape bearing different types of image to be displayed at intervals.

One skilled in the art could devise various modifications and variations, all of which should be deemed to fall within the scope of this invention.

1. Display device of the type comprising:
a sheet made of light-diffusing material;
lighting means positioned on either side of said diffusing layer;
a medium made of transparent material with the image to be displayed applied to it;
characterised in that said diffuser is constituted by a sheet of plastic with at least one surface which presents micro-grooves a few microns deep, so as to form a matt surface, and that said lighting means are constituted by LEDs.

2. Road sign characterised in that it is constituted by a display device as claimed in claim 1, wherein the image displayed is that of the sign.

3. Display device as claimed in claim 1, characterised in that said diffuser is constituted by a sheet of plexiglass.

4. Display device as claimed in claim 3, characterised in that said LEDs are fitted to a removable support, separate from the sheets that form the base of the diffuser and the image support screen.

5. Display device as claimed in claim 1, characterised in that it includes a perimeter frame consisting of an opening structural section designed to allow rapid replacement of the image support sheet.

6. Display device as claimed in claim 1, characterised in that the images are on a sliding tape fitted in front of said diffuser.

7. (canceled)
